(19) United States
(12) Patent Application Publication
(10) Pub. No.: US 2004/0036691 A1
(43) Pub. Date: Feb. 26, 2004

(54) Internal data display apparatus for machine tool

(76) Inventor: Jung-Hong Joo, Hwaseong-city (KR)

Correspondence Address: Pennie & Edmonds, LLP, 3300 Hillview Avenue, Palo Alto, CA, 94304, US

(21) Appl. No.: 10/334,929

(22) Filed: Dec. 31, 2002

(30) Foreign Application Priority Data
Aug. 23, 2002 (KR) 2002-0050095

(51) Int. Cl. G06F 15/167

(52) U.S. Cl. 345/541

(57) ABSTRACT

A internal data display apparatus for a machine tool is provided, which includes a computerized numerical controller (CNC ) being provided with an internal common memory in which internal data is stored; a shared-memory routine module configured to share said internal common memory of said CNC and to receive data from said internal common memory; a hot-link routine module configured to receive data from said shared-memory routine module and to process said received data; a data-view routine module configured to receive data from said hot-link routine module and to display said processed data; a shared-memory data-view file including information on a common memory from which the internal data will be read; and a display data-view file including information on which data of data stored in said shared memory is displayed.

### FIELD OF THE INVENTION

The present invention relates to a computerized numerical controller for machines tools, and more particularly, to a system for displaying internal data of a computerized numerical controller.

### BACKGROUND OF THE INVENTION

Generally, a computerized numerical controller (hereinafter referred to as a CNC) for machine tools is an assembly of complicated software having a high precision and a high operating speed for performing various functions. So under certain conditions, the CNC may operate abnormally.

In such abnormal operations of the CNC, if an operating situation of internal data of the CNC can be observed in real time, it is easy to identify reasons for abnormal operation and to fix problems. However, current CNC does not show the operating situation of the internal data, so it is quite difficult and takes a long time to fix malfunctions of the CNC.

Further, as an example, when a machine tool optimizes parameters of a Z-axis and a spindle in order to make a screw, a rotational speed of the spindle must be synchronized with a moving speed of the Z-axis for precise processing.

Conventionally, a screw is produced with the parameters set as arbitrary values, and then the screw is measured. If the screw is not produced as required, the parameters are changed to other values. These processes are repeated, so a great deal of time is required in order to optimize the parameters.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In a preferred embodiment of the present invention, the internal data display apparatus for a machine tool comprises a computerized numerical controller (CNC), a shared-memory routine module, a hot-link routine module, a data-view routine module, a shared-memory data-view file, and a display data-view file. The CNC is provided with an internal common memory in which internal data is stored. The shared-memory routine module is configured to share the internal common memory of the CNC and to receive data from the internal common memory. The hot-link routine module is configured to receive data from the shared-memory routine module and to process the received data. The data-view routine module is configured to receive data from the hot-link routine module and to display the processed data. The shared-memory data-view file includes information on a common memory from which the internal data will be read. The display data-view file includes information on which data of data stored in the shared memory is displayed.

It is preferable that the data-view routine module is configured to read information on data that will be displayed from the display data-view file, to receive the data from the hot-link routine module, and to display the data on a screen.

Preferably, the shared-memory routine module reads information on a portion of the common memory that will be shared from the shared-memory data-view file, and shares necessary internal data of the CNC, and forwards the shared internal data to the hot-link routine module, wherein the hot-link routine module periodically checks the shared portion of the common memory, and detects and updates data changes, and wherein the data-view routine module reads information on which data of the shared data needs to be displayed, receives data that needs to be displayed from the hot-link routine module, and displays the received data on a screen.

It is preferable that the shared-memory routine module performs: (C1) reading the shared-memory data-view file, and storing a number of a memory group that will be shared into ‘MaxGroupIndex’; (C3) initializing a shared-memory group index ‘GroupIndex’ as 1, and determining whether the ‘GroupIndex’ is less than or equal to the ‘MaxGroupIndex’; (C5) identifying a memory that needs to be shared using a ‘Name’ parameter, sharing the identified memory, and storing a number of a memory item that needs to be shared into ‘MaxItemIndex’; (C7) storing a name of a new memory group that will be formed by the internal data display apparatus into ‘GroupName’, and storing a start address of the memory group that will be shared into ‘GroupIndex’; (C9) initializing ‘ItemIndex’, which is an index of a memory item that is intended to be shared, as 1, and determining whether the ‘ItemIndex’ is less than or equal to the ‘MaxItemIndex’; (C11) storing a name of an item into ‘ItemName’, and storing a type of the item into ‘ItemType; (C13) storing an offset of the item into ‘ItemOffset’, and storing a size of the item into ‘ItemSize’; (C15) storing a sum of ‘GroupOffset’ and ‘ItemOffset’ into ‘SourceAddress’ for an address of the item that will be received, storing an address of ‘GroupName.ItemName’ into ‘DestAddress’ for an address of an item that will be displayed, and copying the memory from ‘SourceAddress’ to ‘DestAddress’ in an amount of ‘Itemsize’; and (C17) increasing ‘ItemIndex’ by 1, and performing step (C9).

Preferably, the shared-memory routine module further performs increasing ‘GroupIndex’ by 1, and determining whether the ‘GroupIndex’ is less than or equal to the ‘MaxGroupIndex’ of step (C3) if the ‘ItemIndex’ is not less than or equal to the ‘MaxItemIndex’ in step (C9).

It is preferable that the hot-link routine module performs: (D1) initializing an item index ‘ItemIndex’ of a memory group as 1 in order to check data changes; (D2) determining whether the ‘ItemIndex’ is less than or equal to ‘MaxItemIndex’; (D3) setting ‘ChangeItemFlag’ as 1 if a stored data ‘GroupName.OlditemName’ is not equal to a current data ‘GroupName.ItemName’, and setting the ‘ChangeItemFlag’ as 0 if the stored data ‘GroupName.OlditemName’ is equal to the current data ‘GroupName.ItemName’, if it is determined that the ‘ItemIndex’ is less than or equal to ‘MaxItemIndex’ in step (D2); (D4) determining whether a flag ‘ChangeItemFlag’ is 1, in order to check whether there is a data change; and (D5) storing the current data if it is determined that the flag ‘ChangeItemFlag’ is 1 in step (D4).

Preferably, the hot-link routine module further performs increasing ‘ItemIndex’ by 1, and performing step (D2), if it is determined that the flag ‘ChangeItemFlag’ is 1 in step (D4).

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a schematic block diagram of an apparatus for displaying internal data of a CNC of a machine tool according to a preferred embodiment of the present invention;

FIG. 2 shows contents of a shared-memory data-view file of FIG. 1;

FIG. 3 shows contents of a display data-view file of FIG. 1;

FIG. 4 is a flowchart of a process performed by the apparatus of FIG. 1;

FIG. 5 is a flowchart of internal processes of the shared-memory routine module of FIG. 1;

FIG. 6 is a diagram illustrating the processes of the shared-memory routine module of FIG. 1; and

FIG. 7 is a flowchart of internal processes of a hot-link routine module of FIG. 1.

### DETAILED DESCRIPTION OF THE PREFERRED EMBODIMENTS

Hereinafter, a preferred embodiment of the present invention will be described in detail with reference to the accompanying drawings.

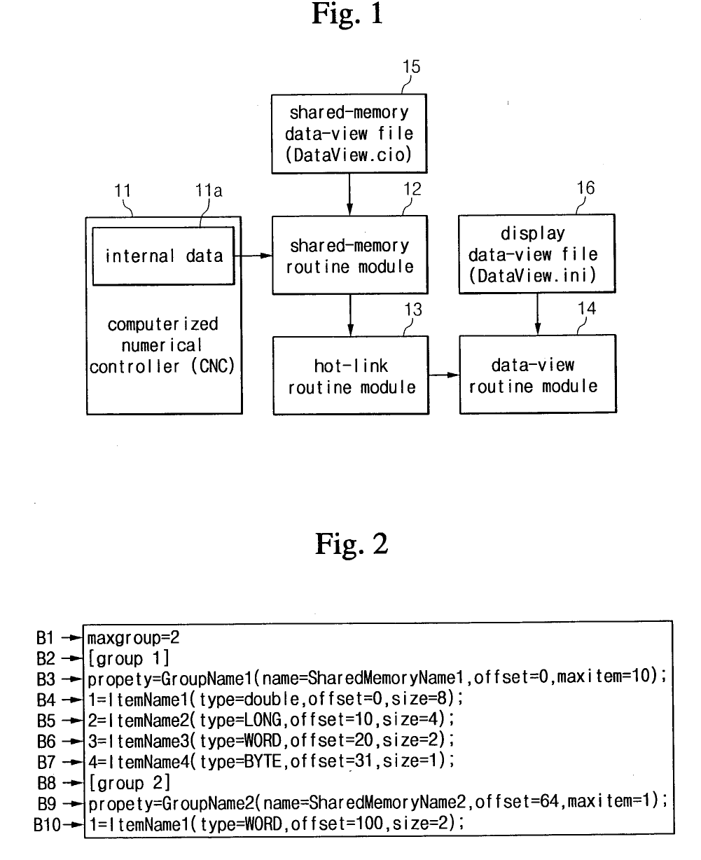

As shown in FIG. 1, a preferred embodiment of the present invention may include a computerized numerical controller (CNC) 11 wherein internal data 11a is stored in a common memory, which each routine can access, inside the CNC 11. A shared-memory routine module 12 reads information on a memory that is to be shared, preferably from a shared-memory data-view file DataView.cio 15. Then, the shared-memory routine module 12 reads data from the shared memory of the common memory of the CNC 11 using the information from the data-view file, and transmits the data from the shared memory to a hot-link routine module 13. The hot-link routine module 13 processes the transmitted internal data.

A data-view routine module 14 reads a display data-view file DataView.ini 16 to acquire information on which data among the shared data is to be displayed. Then, the data-view routine module 14 receives data that is to be displayed from the hot-link routine module 13.

The internal data display apparatus according to a preferred embodiment of the present invention can read necessary data from the internal common memory of the CNC 11 and display them. Therefore, an amount of data that should be periodically checked in order to identify data changes decreases so that processing time of the internal data display apparatus of the CNC controller 11 can be substantially decreased.

As shown in FIG. 2, the shared-memory data-view file DataView.cio 15 includes data B1 (‘maxgroup’) for a number of a memory group that is to be shared. As an example, if ‘maxgroup’ is 2, a number of the memory group is 2. Data B2 indicates a start point of a memory group that will be shared. Data B3 indicates information on the memory group that is to be shared. ‘GroupName1’ is a name of the memory group that will display data received from the internal memory of the CNC 11, ‘Name’ is a name of a memory that will be shared, ‘offset’ is a start address of the memory, ‘maxitem’ is a number of an item that will be taken from the internal common memory of the CNC 11, ‘1’ of data B4 indicates an index of the item, ‘ItemName1’ indicates an item name of a data group that will be displayed, ‘type’ is a type of the data, ‘offset’ indicates an offset of the data, and ‘size’ indicates a size of the data that will be taken. Data B5, B6, B7, and B10 are generally the same as data B4, data B8 is generally the same as data B2, and data B9 is generally the same as the data B3.

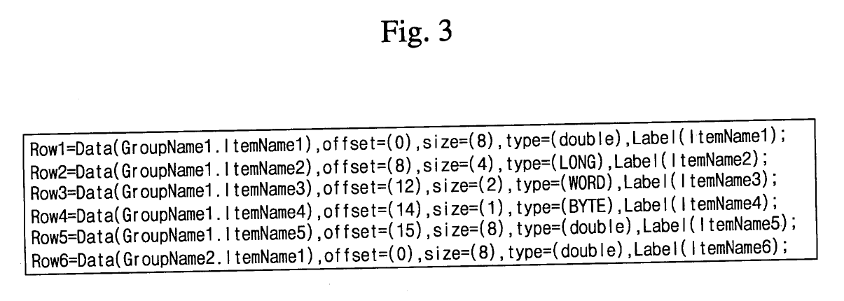

Referring to FIG. 3, the display data-view file DataView.ini 16 includes information for the internal data that will be displayed. Preferably, eight rows of the internal data can be displayed. ‘Row’ indicates a row on a screen, ‘Data’ indicates internal data that will displayed, ‘offset’ is a start address of the data, ‘type’ is a type of the data, and ‘Label’ is a name of the data.

The data-view routine module 14 reads information on data that will be displayed from the display data-view file DataView.ini 16, receives data that will be displayed from the hot-link routine module 13, and displays the data on the screen. The process performed by the data-view routine module 14 is straight forward data conversion understood by persons of ordinary skill in the art, so a further detailed explanation will be omitted.

A method for displaying the internal data of the CNC for the machine tool according to a preferred embodiment of the present invention using the internal data display apparatus will be explained.

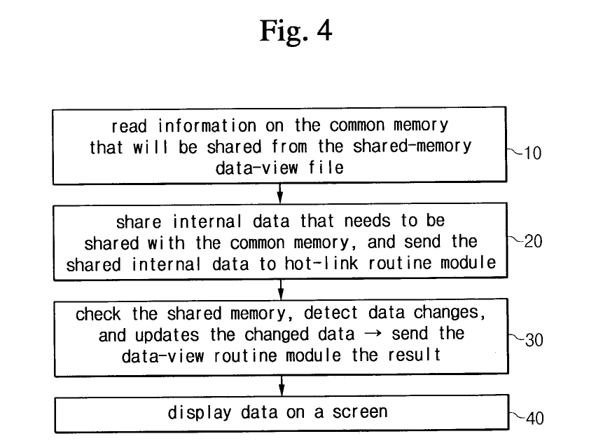

Referring to FIG. 4, the shared-memory routine module 12 reads information on the common memory of the CNC 11 that will be shared from the shared-memory data-view file DataView.CIO 15 in step 10. The shared-memory routine module 12 shares the internal data 11a that is to be shared with the common memory, and sends the shared internal data 11a to the hot-link routine module 13 in step 20.

The hot-link routine module 13 periodically checks the shared memory, detects data changes, and updates the changed data. The hot-link routine module 13 sends the data-view routine module 14 the result in step 30. The data-view routine module 14 takes the data stored in the shared memory from the hot-link routine module 13 using the data of the display data-view file DataView.ini 16, and displays the data on the screen in step 40.

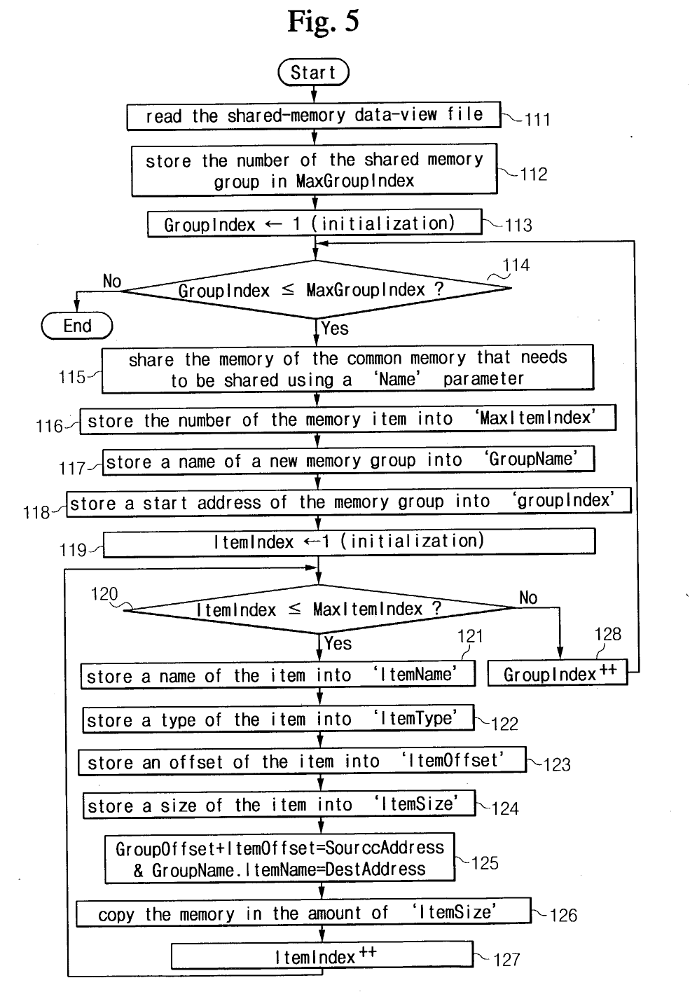

FIG. 5 shows a schematic flowchart of an internal process of the shared-memory routine module 12. The shared-memory routine module 12 reads the shared-memory data-view file DataView.CIO 15 in step 111, and stores the number of the shared memory group of the shared-memory data-view file DataView.CIO 15 in ‘MaxGroupIndex’ in step 112.

Then, the shared-memory routine module 12 initializes ‘GroupIndex’, which is an index of the memory group that is to be shared, as 1 in step 113, and determines whether ‘GroupIndex’ is less than or equal to ‘MaxGroupIndex’ in step 114. If the determination is in the affirmative in step 114, the shared-memory routine module 12 shares the memory of the common memory that is to be shared, using a ‘Name’ parameter, in step 115, and stores the number of the memory item that will be taken from the memory group, which needs to be shared, into ‘MaxItemIndex’, in step 116.

If the determination is in the negative in step 114, the procedure ends.

The shared-memory routine module 12 stores a name of a new memory group that will be formed by the internal data display apparatus into ‘GroupName’ in step 117, and stores a start address of the memory group that will be shared into ‘GroupIndex’ in step 118. The shared-memory routine module 12 initializes ‘ItemIndex’, which is an index of a memory item that will be taken from the memory group that will be shared, as 1, in step 119, and determines whether ‘ItemIndex’ is less than or equal to ‘MaxItemIndex’ in step 120.

If the determination is in the affirmative in step 120, the shared-memory routine module 12 stores a name of the item into ‘ItemName’ in step 121, and stores a type of the item into ‘ItemType’ in step 122. Then, the shared-memory routine module 12 stores an offset of the item into ‘ItemOffset’ in step 123, and stores a size of the item into ‘ItemSize’ in step 124.

The shared-memory routine module 12 stores a sum of an initial offset, i.e., ‘GroupOffset’ and ‘ItemOffset’ into ‘SourceAddress’ for an address of the item that will be taken, and stores an address of ‘GroupName.ItemName’ into ‘DestAddress’ for an address of an item that will be displayed in step 125, and copies the memory from ‘SourceAddress’ to ‘DestAddress’ in the amount of ‘ItemSize’ in step 126.

After step 126, the shared-memory routine module 12 increases ‘ItemIndex’ by 1 in step 127, and the procedure returns to step 120.

Meanwhile, if the determination is in the negative in step 120, the shared-memory routine module 12 increases ‘GroupIndex’ by 1 in step 128, and the procedure returns to step 114.

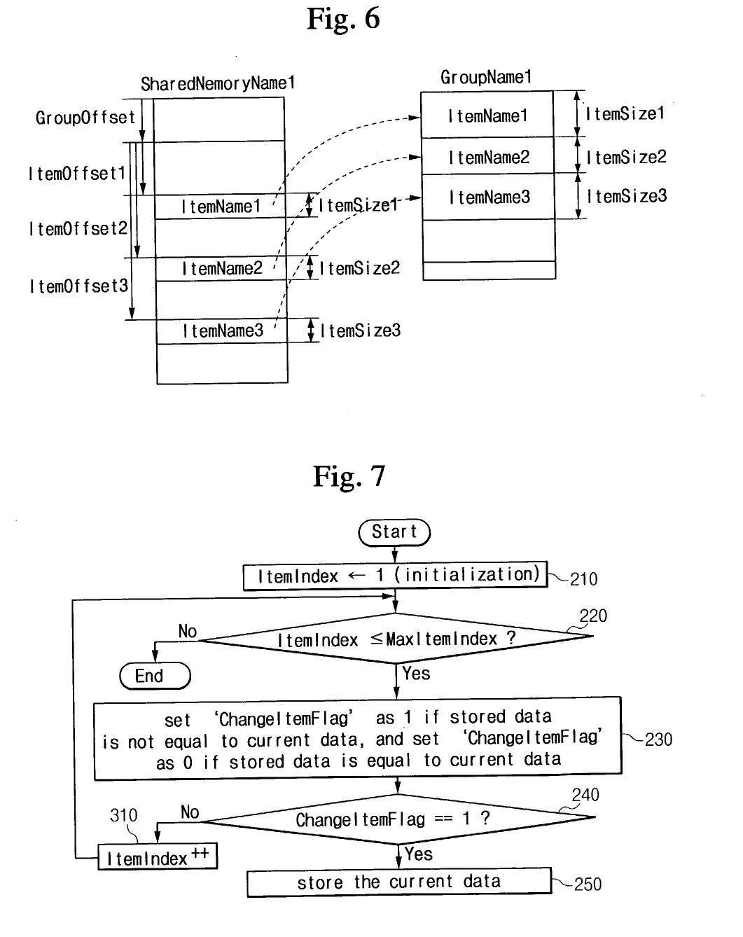

As shown in FIG. 6, because a shared memory ‘Groupname1’, which is used by the internal data display apparatus of the CNC 11 only takes a necessary portion from the internal common memory ‘SharedMemoryName1’ of the CNC 11, the number of data to which the hot-link routine module 13 has to access in order to periodically check data changes so that the processing time of the internal data display apparatus of the CNC substantially decreases.

FIG. 7 is a schematic flowchart of an internal process of a hotlink routine module 13. The hot-link routine module 13 initializes an item index ‘ItemIndex’ of a memory group as 1 in order to check data changes in step 210. Then, the hot-link routine module 13 determines whether ‘ItemIndex’ is less than or equal to ‘MaxItemIndex’ in step 220.

If the determination is in the affirmative in step 220, the hot-link routine module 13 determines whether a stored data ‘GroupName.OlditemName’ is equal to a current data ‘GroupName.ItemName’, and if the determination is in the negative, a flag ‘ChangeItemFlag’ is set as 1, and if the determination is in the affirmative, the flag ‘ChangeItemFlag’ is set as 0 (step 230). If the determination is in the negative in step 220, the procedure ends.

After step 230, the hot-link routine module 13 determines whether the flag ‘ChangeItemFlag’ is 1 or not in order to check whether there is a data change in step 240. If the determination is in the affirmative in step 240, the current data is stored in step 250. If the determination is in the negative in step 240, the hot-link routine module 13 increases ‘ItemIndex’ by 1 in step 310 and returns to step 220.

In the internal data display method for the CNC according to the preferred embodiment of the present invention, changing situations of the internal data can be seen in real time when the CNC abnormally operates.

Therefore, it is easy to know reasons for abnormal operations and to fix the abnormal operations of the CNC. For example, parameters of the Z-axis and the spindle during a process of making screw can be optimized.

So, unnecessary test processes can be omitted so that a consumption of test material can be decreased, and the machine tool can be protected from damage caused by use of non-optimized parameters.

Although preferred embodiments of the present invention have been described in detail hereinabove, it should be clearly understood that many variations and/or modifications of the basic inventive concepts herein taught which may appear to those skilled in the present art will still fall within the sprit and scope of the present invention, as defined in the appended claims.

Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. An internal data display apparatus for a machine tool, comprising:
a computerized numerical controller (CNC ) being provided with an internal common memory in which internal data is stored;
a shared-memory routine module configured to share said internal common memory of said CNC and to receive data from said internal common memory;
a hot-link routine module configured to receive data from said shared-memory routine module and to process said received data;
a data-view routine module configured to receive data from said hot-link routine module and to display said processed data;
a shared-memory data-view file including information on a common memory from which the internal data will be read; and
a display data-view file including information on which data of data stored in said shared memory is displayed.

2. The internal data display apparatus of claim 1, wherein said data-view routine module is configured to read information on data that will be displayed from said display data-view file, to receive the data from said hot-link routine module, and to display the data on a screen.

3. The internal data display apparatus of claim 1, wherein:
said shared-memory routine module reads information on a portion of said common memory that will be shared from said shared-memory data-view file, and shares internal data of the CNC, and forwards the shared internal data to said hot-link routine module;
said hot-link routine module periodically checks said shared portion of said common memory, and detects and updates data changes; and
said data-view routine module reads information on which data of said shared data needs to be displayed, receives data that needs to be displayed from said hot-link routine module, and displays said received data on a screen.

4. The internal data display apparatus of claim 3, wherein said shared-memory routine module performs:
(C1) reading said shared-memory data-view file, and storing a number of a memory group that will be shared;
(C3) initializing a shared-memory group index, and determining whether said group index is less than or equal to said stored memory group number;
(C5) identifying a memory that is to be shared, sharing said identified memory, and storing a number of a memory item that is to be shared;
(C7) storing a name of a new memory group that will be formed by said internal data display apparatus, and storing a start address of the memory group that will be shared;
(C9) initializing an index of a memory item that is intended to be shared, and determining whether said index is less than or equal to said stored number of a memory item that is to be shared;
(C11) storing a name of an item and storing a type of the item;
(C 13) storing an offset of the item, and storing a size of the item;
(C15) storing a sum of an initial offset and said item offset as an address of the item that will be received, storing an address comprising said new memory group name and said item name as an address of an item that will be displayed, and copying said stored sum to the address to be received in an amount of said stored item size; and
(C17) incrementing said memory item index and return to step (C9).

5. The internal data display apparatus of claim 4, wherein said shared-memory routine module further performs incrementing said shared memory group index and determining whether said group index is less than or equal to said stored memory group number of step (C3) if said memory item index is not less than or equal to said stored memory item number in step (C9).

6. The internal data display apparatus of claim 3, wherein said hot-link routine module performs:
(D1) initializing an item index of a memory group in order to check data changes;
(D2) determining whether said item index is less than or equal to a stored memory item number;
(D3) turning on a flag if a stored data ffor a group name and item name is not equal to current data for the group name and item name, and turning off said flag if said stored data is equal to said current data, if it is determined that said item index is less than or equal to the shared memory item number in step (D2);
(D4) determining whether the flag is on, in order to check whether there is a data change; and
(D5) storing said current data if it is determined that said flag is on in step (D4).

7. The internal data display apparatus of claim 6, wherein said hot-link routine module further performs incrementing the item index, and performing step (D2), if it is determined that said flag is on in step (D4).
